(19) United States
(12) Patent Application Publication
(10) Pub. No.: US 2025/0171011 A1
(43) Pub. Date: May 29, 2025

(54) WHEEL POSITIONING FOR TYRE CHAIN DEPLOYMENT

(71) Applicant: VOLVO TRUCK CORPORATION, Göteborg (SE)

(72) Inventors: Esteban GELSO, Västra Frölunda (SE); Leo LAINE, Göteborg (SE); Nrupathunga ASHOK, Göteborg (SE)

(73) Assignee: VOLVO TRUCK CORPORATION, Göteborg (SE)

(21) Appl. No.: 18/955,023

(22) Filed: Nov. 21, 2024

(30) Foreign Application Priority Data
Nov. 28, 2023 (EP) 23212642.5

(51) Int. Cl. B60W 30/00; B60G 17/017; B60W 10/184; B60W 10/20; B60W 10/22

(52) U.S. Cl. CPC B60W 30/00; B60W 10/184; B60W 10/20; B60W 10/22; B60G 17/017; B60W 2710/18; B60W 2710/207; B60W 2710/22

(57) ABSTRACT

A computer system is disclosed comprising processing circuitry configured to receive a message relating to a wheel rotation step of a tyre chain deployment process for a vehicle, and, in response to receiving the message, cause a rotation of the at least one wheel of the vehicle.

### TECHNICAL FIELD

The disclosure relates generally to vehicle control. In particular aspects, the disclosure relates to wheel positioning for tyre chain deployment. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Tyre chains are devices fitted to the tyres of vehicles to provide increased traction in certain situations, for example when driving through snow, ice, or mud, or driving on a slope. In some places, tyre chains are mandatory during certain parts of the year. To attach tyre chains, an operator of a vehicle typically positions unconnected chains over or near the wheels of a vehicle, drive the vehicle forward or backward so that the chains are passed around the wheel, and then connect the chains so that they are attached to the wheel. This process is time consuming and cumbersome, especially in adverse weather conditions (snowy, cold, wet, etc.). Precise movement of the vehicle is required, which may be difficult due to limited space in the surroundings or traction problems caused by a slippery surface (e.g. snow or ice).

It is therefore desired to provide systems, methods and other approaches that attempt to resolve or at least mitigate one or more of these issues.

### SUMMARY

This disclosure provides systems, methods and other approaches for positioning at least one wheel of a vehicle to enable deployment (attachment to or detachment from the wheel) of tyre chains. In particular, an operator may provide inputs relating to respective steps of a tyre chain deployment process (for example, initiate tyre chain deployment, rotate wheel, steer wheel, raise wheel, etc.). In response to receiving an input, an appropriate action may be performed. In particular, an operator may provide an input relating to rotation of a wheel and the wheel is rotated. In some examples, a vertical load the wheel may be decreased, and/or the vertical position of the wheel may be raised, before the wheel is rotated and the chain is attached or detached. Rotating the wheel may facilitate the process of attaching or detaching a chain, in particular in combination with lifting or reducing the load on the wheel. This reduces the time required to complete the process and can ensure sufficiently precise movement of the vehicle where necessary.

According to a first aspect of the disclosure, there is provided a computer system comprising processing circuitry configured to receive a message relating to a wheel rotation step of a tyre chain deployment process for a vehicle, and, in response to receiving the message, cause a rotation of the at least one wheel of the vehicle.

The first aspect of the disclosure may seek to provide a more efficient and less cumbersome process for deployment of tyre chains. Rotating the wheel in response to an input from a vehicle operator may facilitate the process of attaching or detaching a chain, in particular in combination with lifting or reducing the load on the wheel. The tyre chain deployment process can be completed without the operator having to enter the vehicle, engage/disengage the parking brake, drive the vehicle forwards or backwards, and then exit the vehicle to connect the remainder of the chain. This reduces the time required to complete the process and can ensure sufficiently precise movement of the vehicle where necessary.

Optionally in some examples, including in at least one preferred example, the rotation is a specific angular rotation of the at least one wheel of the vehicle. A technical benefit may include that a precise rotation of the wheel can be implemented corresponding to the rotation required to deploy the chain, meaning that the tyre chain deployment process can be employed when there is limited space in the surroundings or there are traction problems caused by a slippery surface.

Optionally in some examples, including in at least one preferred example, the processing circuitry is further configured to cause braking of one or more other wheels of the vehicle while the at least one wheel is rotated. A technical benefit may include ensuring that the vehicle does not move while the wheel is rotated, which is advantageous in instances where there is limited space.

Optionally in some examples, including in at least one preferred example, the processing circuitry is further configured to cause a steering angle to be applied to the at least one wheel of the vehicle. A technical benefit may include that a wheel can be turned inwards or outwards to provide better access to the connections of the chain.

Optionally in some examples, including in at least one preferred example, the processing circuitry is further configured to cause a vertical load on at least one wheel of the vehicle to be decreased or increased. A technical benefit may include enabling easier rotation of the wheel, for example without moving the vehicle, which is advantageous in instances where there is limited space.

Optionally in some examples, including in at least one preferred example, the processing circuitry is further configured to cause a vertical position of at least one wheel of the vehicle to be raised or lowered. A technical benefit may include enabling easier rotation of the wheel, for example without moving the vehicle, which is advantageous in instances where there is limited space or there are traction problems due to slippery surfaces.

Optionally in some examples, including in at least one preferred example, the processing circuitry is configured to receive a first message relating to a first step of the tyre chain deployment process for the vehicle and, in response to receiving the first message, cause a vertical load on at least one wheel of the vehicle to be decreased and/or a vertical position of at least one wheel of the vehicle to be raised, receive the message relating to a wheel rotation step as a second message relating to a second step of the tyre chain deployment process for the vehicle and, in response to receiving the second message, cause the rotation of the at least one wheel of the vehicle receive a third message relating to a third step of the tyre chain deployment process for the vehicle, and, in response to receiving the third message, cause a vertical load on the at least one wheel of the vehicle to be increased and/or a vertical position of the at least one wheel of the vehicle to be lowered. A technical benefit may include that a tyre chain deployment process can be completed without the operator having to re-enter the vehicle, and in which a wheel can be rotated more easily, providing a more efficient tyre chain deployment process that can be employed in instances where there is limited space and traction problems due to slippery surfaces are avoided.

Optionally in some examples, including in at least one preferred example, the processing circuitry is configured to receive the message via a user interface of the vehicle or a user device of a vehicle operator. A technical benefit may include that the operator can control the entire tyre chain deployment process without having to enter the vehicle and exit the vehicle.

Optionally in some examples, including in at least one preferred example, the message comprises a user input to a touch screen, a user gesture captured by a camera, or a voice command captured by a microphone. A technical benefit may include that the operator can control the entire tyre chain deployment process in a number of different ways, without having to enter the vehicle and exit the vehicle.

Optionally in some examples, including in at least one preferred example, the at least one wheel of the vehicle is an individual wheel of the vehicle or comprises two wheels on a common axle of the vehicle. A technical benefit may include that a tyre chain deployment process can be employed for different combinations of wheels and axles, therefore providing enhanced flexibility.

Optionally in some examples, including in at least one preferred example, the at least one wheel of the vehicle is a driven wheel of the vehicle. A technical benefit may include that a tyre chain deployment process can be employed for the wheels of a vehicle that provide traction, therefore improving overall control of the vehicle.

According to a second aspect of the disclosure, there is provided a vehicle comprising the computer system. The second aspect of the disclosure may seek to provide a vehicle for which a more efficient and less cumbersome process for deployment of tyre chains is available.

According to a third aspect of the disclosure, there is provided a computer-implemented method comprising, by processing circuitry of a computer system, receiving a message relating to a wheel rotation step of a tyre chain deployment process for a vehicle, and, in response to receiving the message, causing a rotation of the at least one wheel of the vehicle.

The third aspect of the disclosure may seek to provide a more efficient and less cumbersome process for deployment of tyre chains. Rotating the wheel in response to an input from a vehicle operator may facilitate the process of attaching or detaching a chain, in particular in combination with lifting or reducing the load on the wheel. The tyre chain deployment process can be completed without the operator having to enter the vehicle, engage/disengage the parking brake, drive the vehicle forwards or backwards, and then exit the vehicle to connect the remainder of the chain. This reduces the time required to complete the process and can ensure sufficiently precise movement of the vehicle where necessary.

According to a fourth aspect of the disclosure, there is provided a computer program product comprising program code for performing, when executed by processing circuitry, the computer-implemented method. A technical benefit may include that new vehicles and/or legacy vehicles may be conveniently configured, by software installation/update, to benefit from a more efficient and less cumbersome process for deployment of tyre chains.

According to a fifth aspect of the disclosure, there is provided a non-transitory computer-readable storage medium comprising instructions, which when executed by processing circuitry, cause the processing circuitry to perform the computer-implemented method. A technical benefit may include that new vehicles and/or legacy vehicles may be conveniently configured, by software installation/update, to benefit from a more efficient and less cumbersome process for deployment of tyre chains.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIGS. 1A and 1B schematically show a vehicle, according to an example.

FIGS. 2A to 2C illustrate the steps of a tyre chain deployment process, according to an example.

FIG. 3 is a flow chart of a computer-implemented method, according to an example.

FIG. 4 is a flow chart of a computer-implemented method, according to an example.

FIG. 5 is a schematic diagram of an exemplary computer system for implementing examples disclosed herein, according to an example.

Like reference numerals refer to like elements throughout the description.

### DETAILED DESCRIPTION

The detailed description set forth below provides information and examples of the disclosed technology with sufficient detail to enable those skilled in the art to practice the disclosure.

To attach tyre chains, an operator of a vehicle must typically position unconnected chains over or near the wheels of a vehicle, drive the vehicle forward or backward so that the chains are passed around the wheel, and then connect the chains so that they are attached to the wheel. This process is time consuming and cumbersome, especially in adverse weather conditions (snowy, cold, wet, etc.). Precise movement of the vehicle is required, which may be difficult due to limited space in the surroundings or traction problems caused by a slippery surface (e.g. snow or ice).

To remedy this, systems, methods and other approaches are provided for positioning at least one wheel of a vehicle to enable deployment of tyre chains (attachment or detachment of the chains to the wheel). In particular, an operator may provide inputs relating to respective steps of a tyre chain deployment process, in response to which an appropriate action may be performed. In particular, the wheel may be rotated. In some examples, a vertical load on the wheel may be decreased, and/or the vertical position of the wheel may be raised, before the wheel is rotated and the chain is attached or detached. Rotating the wheel may facilitate the process of attaching or detaching a chain, in particular in combination with lifting or reducing the load on the wheel. This reduces the time required to complete the process and can ensure sufficiently precise movement of the vehicle where necessary.

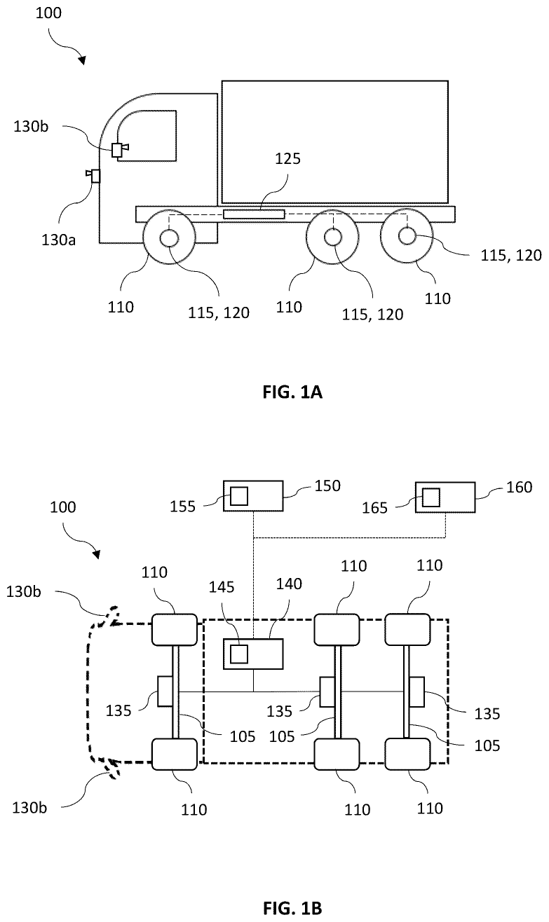

FIGS. 1A and 1B schematically show an example vehicle 100 of the type considered in this disclosure. FIG. 1A shows a side view of the vehicle 100, while FIG. 1B shows a top view of the vehicle 100. The vehicle 100 may be any suitable form of vehicle. For example, the disclosure can be applied in heavy-duty vehicles, such as trucks, buses, and construction equipment, in personal vehicles such as cars, vans, or motorbikes, or in any other suitable form of vehicle.

The vehicle 100 comprises a number of axles 105, each generally having two or more wheels 110. Whilst three axles 105 are shown, it will be appreciated that any suitable number of axles 105 may be provided. It will also be appreciated that any number of the axles 105 may be driven axles. It will also be appreciated that more than two wheels 110 may be provided on each axle.

The vehicle 100 may comprise one or more sources of propulsion configured to drive, e.g. provide torque and/or steering to, one or more axles 105 or individual wheels 110 of the vehicle 100. For example, the vehicle 100 may comprise one or more electrical machines 115 such as electric motors and/or generators. The vehicle 100 may comprise one or more batteries (not shown) configured to provide power to the electrical machines 115. The electrical machines 115 are configured to drive one or more axles 105 or individual wheels 110 of the vehicle 100. The electrical machines 115 can supply either a positive (propulsion) or negative (braking) force. In some examples, the vehicle 100 may also include another source of propulsion, for example an internal combustion engine (ICE). The vehicle 100 also comprises a drivetrain (not shown) to deliver mechanical power from the propulsion source (the electrical machines 115 or the ICE) to the wheels 110.

Furthermore, the vehicle 100 may comprise one or more sets of service brakes 120. The service brakes 120 can supply a negative (braking) force. The service brakes 120 may be, for example, frictional brakes such as pneumatic brakes. Pneumatic brakes use a compressor to fill the brake with air, which may be powered by the batteries. In some examples, the brakes may be electro-mechanical brakes.

The vehicle 100 may also comprise a suspension system 125. The suspension system 125 may comprise components that allow relative motion between the wheels 110 and the rest of the vehicle 100 as known in the art, in order to provide a smooth ride, maintain proper wheel contact with the road surface, and ensure stable handling and control of the vehicle 100. The suspension system 125 may be an active suspension system that uses electronic and hydraulic systems to actively control the suspension settings of the vehicle 100 in real-time, for example a gas-hydraulic active suspension system. An active suspension system may continuously adjust the suspension settings based on various inputs, such as road conditions, vehicle speed, acceleration, and braking.

In some examples, one or more cameras 130 may be disposed on the vehicle 100 in order to capture images of the vehicle 100 and its environment. For example, the vehicle 100 may comprise one or more forward facing cameras 130a and one or more rearward-facing cameras 130b. In this example, the vehicle 100 comprises a forward-facing camera 130a mounted on the front of vehicle 100 and two rearward-facing cameras 130b embodied as side-view cameras mounted on the side of the vehicle 100. Such cameras are known in the art and may be coupled to an associated display intended to replace traditional wing mirrors. In some examples, the cameras 130 may be video cameras. It will be appreciated that any number of cameras 130 could be mounted at any suitable location on the vehicle 100.

The vehicle 100 may also comprise a steering system 135. The steering system 135 may comprise or more steering arrangements for each axle 105 and/or wheel 110 of the vehicle 100. In some examples, steering system 135 may be embodied in one or more of the electrical machines 115 of the vehicle 100. As such, the vehicle 100 can be steered by driving only certain wheels 110 while the vehicle 100 is in motion. For example, if the right side wheels 110 are driven while the left side wheels 110 are braked, a yaw moment is created. In some examples, individual axles 105 and/or wheels may be steered when the vehicle is at standstill. This can be achieved using a steered axle 105, for example using a steering system 135 such as the Volvo Dynamic Steering (VDS) system. VDS has a control unit, a hydraulic steering gear, and an electric motor. The electric motor can add a torque on the operator's steering wheel based on a request from the control unit.

The vehicle 100 may also comprise a controller 140 comprising processing circuitry 145. The controller 140 is configured to control components of the vehicle 100, for example the electrical machines 115, the service brakes 120, the suspension system 125, and the steering system 135. FIG. 1B shows a common controller 140 for all components of the vehicle 100, however it will be appreciated that each component may have its own respective controller 140. In many cases, the controller 140 may be implemented in the structure of the component itself. The controller 140 may be a microcontroller. In examples where the vehicle 100 is a vehicle combination, the vehicle 100 may include a global controller and a plurality of unit controllers, for example a controller for each unit.

The controller 140 may receive control signals from a computer system 150 comprising processing circuitry 155. The computer system 150 may be a vehicle control unit configured to perform various vehicle control functions, such as vehicle motion management. The computer system 150 may be local to the vehicle 100, or may be a remote system, implemented at a distance from the vehicle 100. The computer system 150 may be communicatively coupled to the controller 140 in any suitable way, for example via a circuit or any other wired, wireless, or network connection known in the art. Furthermore, the communicative coupling may be implemented as a direct connection between the controller 140 and the computer system 150, or may be implemented as a connection via one or more intermediate entities.

One function of the controller 140 and the computer system 150 is to provide control inputs for the vehicle 100, for example motion requests for the wheels 110. These motion requests may relate to a requested manoeuvre for the vehicle 100, for example, straight-line driving, cornering, braking and the like. These control inputs can be provided for individual wheels 110, meaning that the wheels 110 can be controlled independently of each other. This function can be used when positioning a wheel 110 to enable deployment of tyre chains.

The controller 140 may also receive control signals from a user device 160 comprising processing circuitry 165. The user device 160 may be any suitable user device known in the art, for example a personal user device such as a smart phone, tablet, laptop, or the like. The user device 160 may comprise a touch screen that enables a user to input commands or instructions to the device for controlling functions of the vehicle. The user device 160 may be communicatively connected to the vehicle 100, for example to the controller 140 and/or the computer system 150. Furthermore, the communicative coupling may be implemented as a direct connection between the user device 160 and vehicle 100, or may be implemented as a connection via one or more intermediate entities.

The vehicle 100 may be a vehicle combination comprising a number of units, including a tractor unit and at least one trailing unit. In some examples, the vehicle 100 may be a vehicle combination comprising a number of units, including a tractor unit and at least one trailing unit. In such examples, each unit may comprise its own electrical machines 115, batteries, service brakes 120, controllers 140, and the like.

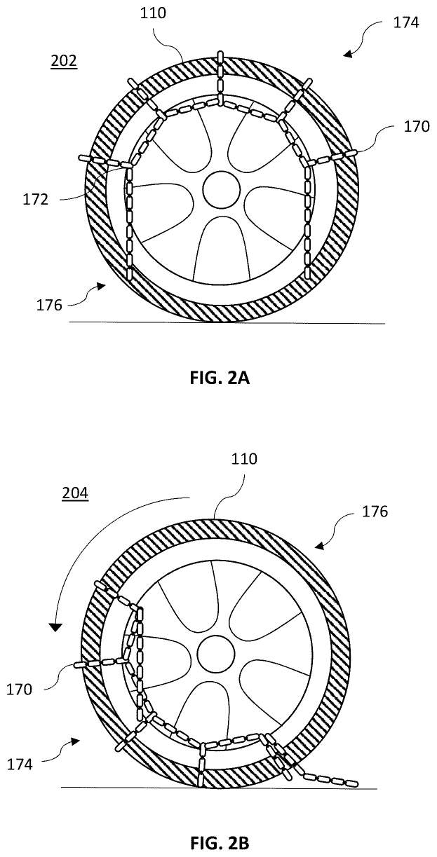

FIGS. 2A to 2C illustrate the steps 202 to 206 of an example tyre chain deployment process. When performed in order, steps 202 to 206 relate to a tyre chain attachment process. It will be appreciated that, if performed in reverse, steps 202 to 206 relate to a tyre chain detachment process. As such, the term “deployment” is used herein to refer to attachment and/or detachment of tyre chains.

As shown in FIG. 2A, at 202, when the vehicle 100 is at a standstill, a tyre chain 170 may be draped over a wheel 110 of the vehicle 100. The tyre chain 170 may be held on the wheel 110 via tightening the links of the chain 170, or may be connected to the wheel 110 at one or more connection points 172. The connected part of the tyre chain 170 may be referred to as an assembled part 174 of the tyre chain 170. An open or unassembled part 176 of the chain 170 may hang down from the top of the wheel 110. This step may be performed manually by an operator of the vehicle 100, for example after stopping the vehicle 100 and engaging the parking brake.

As shown in FIG. 2B, at 204, the wheel 110 is driven such that the assembled part 174 of the tyre chain 170 is moved to a side or even under the wheel 110, and the unassembled part 176 of the chain 170 and corresponding part of the wheel 110 are exposed and accessible. The wheel 110 may be driven either forwards or backwards relative to the normal direction of motion of the vehicle 100. This step is usually performed by the operator entering the vehicle 100, disengaging the parking brake, and causing a movement of the wheel 110, for example by causing a forward or backward motion of the vehicle 100.

At 206, the exposed unassembled part 176 of the chain 170 can then be connected, such that the entire chain 170 is attached to the wheel 110. This step may again be performed manually by an operator of the vehicle 100, for example after stopping the vehicle 100 and engaging the parking brake. The attachment of the entire chain 170 is shown in FIG. 2C.

An alternative tyre chain deployment process may involve the operator of the vehicle 100 laying the chain 170 in front of or behind the wheel 110, then driving the vehicle over the chain in order to connect the unassembled part 176 of the chain 170.

These methods require the operator to position the unconnected chain 170 over or near the wheel 110, enter the vehicle 100, engage/disengage the parking brake, drive the vehicle 100 forwards or backwards so that the chain 170 is passed around the wheel 110, and then exit the vehicle to connect the remainder of the chain 170 so it is attached to the wheel 110. A similar process is required in reverse to remove the chain 170 from the wheel 110. This is time consuming and cumbersome, especially in adverse weather conditions (snowy, cold, wet, etc.), where the operator may also need to remove or put on winter clothing such as gloves and a jacket. Precise movement of the vehicle 100 is required, which may be difficult due to limited space in the surroundings or traction problems caused by a slippery surface.

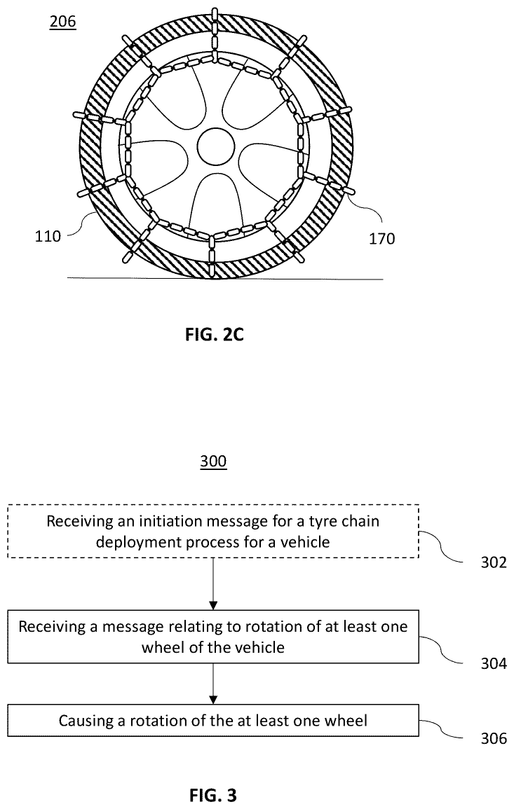

FIG. 3 is a flow chart of a computer-implemented method 300 according to an example. The method 300 enables deployment of a tyre chain 170 on a wheel 110 of the vehicle 100 in an improved manner. The method 300 may be performed by the controller 140 and/or the computer system 150, for example by the processing circuitry 145 and/or the processing circuitry 155.

At 302, an initiation message for a tyre chain deployment process may be received. For example, the operator of the vehicle may put the vehicle 100 into a particular mode of operation for tyre chain deployment. To enter this mode of operation, it may be required that the vehicle 100 is at a standstill and that the parking brake is engaged. The initiation message may be generated based on an input provided to the vehicle 100 by the operator.

In some examples, the operator may interact with a user interface located in the cabin of the vehicle 100, for example a central console or dashboard. The operator may make an input to the user interface, such as a button press, actuation of a pedal, press or flick of a switch, interaction with a touch screen, voice command captured by a microphone, visual gesture captured by a camera, or other suitable input.

Alternatively, the the operator may interact with a user interface located outside the vehicle 100, for example with the user device 160. The operator may make an input to the user device 160, such as a button press, interaction with a touch screen, voice command captured by a microphone, visual gesture captured by a camera, or other suitable input. In some examples, a visual gesture may be captured by a camera 130 disposed on the vehicle 100. In some examples, the operator input may be a predetermined operator input such as holding down a button for a predetermined time, pressing a number of buttons may be simultaneously, or making a specific sequence of inputs may in order to generate the initiation message. The operator may be provided with feedback, for example visual, audio, or tactile feedback, indicating that the initiation message has been generated and the tyre chain deployment mode has been entered.

Once the tyre chain deployment mode has been entered, the operator may position the tyre chain 170 accordingly. For example, the tyre chain 170 may be draped over at least one wheel 110 of the vehicle 100, as in 202, or laid in front of or behind the wheel 110. The wheel 110 to which the chain 170 is to be attached is typically a driven wheel of the vehicle 100, as these are the wheels that provide traction for the vehicle 100. In some examples, a chain 170 may be attached to a single wheel 110 of the vehicle 100, whilst in other examples the chain 170 may be attached to multiple wheels 110 of the vehicle 100, for example two wheels 110 on a common axle 105 of the vehicle 100, or indeed wheels 110 on a multiple axles 105 of the vehicle 100, for example driven axles.

At 304, a message is received relating to a wheel rotation step of a tyre chain deployment process for a vehicle. For example, a message may be received relating to a rotation of at least one wheel 110 of the vehicle 100. In some examples, an initiation message is not required, and a tyre chain deployment process may be initiated based only on receiving a suitable message at 304. The message may specify that at least one wheel 110 or axle 105 of the vehicle 100 is to be rotated, for example in a longitudinal direction.

The message may be generated based on an input provided by the operator. For example, the operator may interact with a user interface located inside or outside of the vehicle 100, in the same manner discussed in relation to 302. In examples where the operator interacts with a user interface located outside of the vehicle 100, the operator does not need to re-enter the vehicle after positioning the chain 170. In some examples, the operator may make an input to the user device 160, such as a button press, interaction with a touch screen, voice command captured by a microphone, visual gesture captured by a camera, or other suitable input. In some examples, a visual gesture may be captured by a camera 130 disposed on the vehicle 100, for example a rearward-facing camera 130b.

The operator input may correspond to one or more particular wheels 110 or axles 105. For example, a particular button may be pressed in an application on a user device, a particular voice command may be given, or a particular gesture may be made, that specifies which wheels 110 or axles 105 are to be rotated. In some examples, the operator input may correspond to all driven wheels 110 or axles 105 of the vehicle 100. As such, a message may be generated relating to rotation of one or more specific wheels 110 or axles 105 of the vehicle 100.

The operator input may correspond to a particular angular rotation of a wheel 110. For example, a particular button may be pressed in an application on a user device, a particular voice command may be given, or a particular gesture may be made, that specifies a number of degrees through which the wheel 110 is to be rotated. For example, it may be specified that the wheel 110 should be rotated a suitable number of degrees to expose the unassembled part 176 of the chain 170, as in 204. The number of degrees may be any appropriate value, for example 80 degrees. As such, a message may be generated correspond to a specific rotation of a wheel 110 or axle 105 of the vehicle 100. Enabling a precise rotation of the wheel 110 is advantageous when there is limited space in the surroundings or there are traction problems caused by a slippery surface.

At 306, in response to receiving the message at 304, a rotation of the at least one wheel 110 of the vehicle 100 is caused. In particular, a rotation of the wheel 110 may be caused that exposes the unassembled part 176 of the chain 170 and corresponding part of the wheel 110, as in 204. The rotation may be provided by actuators associated with the wheel, for example one or more electrical machines 115 or service brakes 120. As tyre chains 170 are typically attached to a driven wheel 110 or axle 105 of the vehicle 100, it is possible to use the existing propulsion systems in the vehicle 100.

In some examples, a specific angular rotation of the at least one wheel 110 of the vehicle 100 is caused. For example, a specific angular rotation may be contained in the message at 304, as discussed above. In some examples, a default angular rotation may be set, which is then implemented in response to receiving the message at 304. In the case of an electric motor, a particular angular rotation of the motor corresponds to a particular angular rotation of the wheel 110. The person skilled in the art will understand how to determine the specific angular rotation of the motor based on parameters such as wheel circumference and gear ratio. Accurate rotation of the wheel 110 can enable simpler connection of the chain 170 as it can be ensured that the unassembled part 176 of the chain 170 and corresponding part of the wheel 110 are in the correct position for the operator to connect the chain 170. Enabling a precise rotation of the wheel 110 is advantageous when there is limited space in the surroundings or there are traction problems caused by a slippery surface. Anti-lock braking systems (ABS), anti-slip-regulation (ASR), or other traction control strategies may also be implemented to take wheel slip into account when necessary (e.g. on low friction surfaces such as ice or mud).

In some examples, if the resultant rotation of the wheel 110 is not sufficient, for example if the unassembled part 176 of the chain 170 and corresponding part of the wheel 110 are not adequately exposed, the operator may be enabled to make an additional input specifying a further rotation of the wheel 110. In some examples, a the operator may be able to input a specific further rotation, whilst in other examples, a default further rotation may be set, for example 10 degrees, which is then implemented in response to an additional input and corresponding message.

Once the wheel 110 has been rotated, the operator may connect the exposed unassembled part 176 of the chain 170, such that the entire chain 170 is attached to the wheel 110. As such, the tyre chain deployment process can be completed without the operator having to re-enter the vehicle, which is more efficient as there is no need for the operator to enter the vehicle 100, engage/disengage the parking brake, drive the vehicle 100 forwards or backwards so that the chain 170 is passed around the wheel 110, and then exit the vehicle to connect the remainder of the chain 170.

Whilst the tyre chain deployment process disclosed in relation to FIG. 3 relates to attachment of a chain 170, it will be appreciated that it can also be applied in order to detach a chain 170 from a wheel 110. For example, the operator may detach or decouple part of the chain 170 before making an input relating to rotation of the wheel 110 at 304. The rotation may then be caused at 306, enabling the operator to remove the entire chain 170 from the wheel 110.

In some examples, other functions relating to the wheel 110 may also be performed as part of the tyre chain deployment process. These may be caused in response to receiving the message at 304, or in response to receiving specific messages relating to particular functions.

In some examples, braking of one or more other wheels 110 of the vehicle 100 is caused while the specified wheel 110 or axle 105 is rotated. This can be performed, for example, in vehicles 100 with an open differential (or with an unlocked locking differential). This ensures the vehicle 100 remains stable while the wheel 110 is rotated. This also means that the vehicle 100 does not move while the wheel 110 is rotated, which is advantageous in instances where there is limited space. This is particularly useful in the case of large vehicles such as trucks, buses, construction equipment, and the like.

In some examples, a steering angle is applied to the specified wheel 110 or axle 105. For example, the steering system 135 may be caused to apply a steering angle one or more wheels 110 or axles 105. For example, a steering angle can be applied to a steered axle 105 by providing a torque request to an electrical machine 115 of the steered steered axle 105, e.g. based on a request from a control unit of a VDS system. By applying a steering angle, a wheel 110 can be turned inwards or outwards to provide better access to the connections of the chain 170 and corresponding part of the wheel 110. Any suitable steering angle may be applied, for example a predefined angle or maximum steering capability. Wheels 110 on opposite sides of the vehicle 100 may be turned in opposite directions to provide better access to the connections of the chain 170 on both sides of the vehicle 100.

In some examples, a vertical load on the specified wheel 110 or axle 105 may be reduced. For example, the suspension system 125, such as an active suspension system, may be caused to reduce the load on one or more wheels 110 or axles 105. By reducing the load on a wheel 110 or axle 105, the wheels 110 can be rotated more easily, for example without moving the vehicle 100, which is advantageous in instances where there is limited space. At the end of the tyre chain deployment process, the vertical load may be increased to the previous level or a normal level for operation of the vehicle.

In some examples, a vertical position of the specified wheel 110 or axle 105 may be raised. For example, the suspension system 125, for example an active suspension system, may be caused to raise the position of one or more wheels 110 or axles 105. By raising the vertical position of a wheel 110 or axle 105, the wheels 110 can be rotated without moving the vehicle 100 and traction problems due to slippery surfaces are avoided. At the end of the tyre chain deployment process, the vertical position may be lowered to the previous or normal level. In the case that the vehicle 100 has more than three wheels 110, raising an individual wheel 110 will not compromise the stability of the vehicle 100 as there will still be three points of contact on the ground. Similarly, in the case that the vehicle 100 has more than two axles 105, raising an individual axle 105 will not compromise the stability of the vehicle 100.

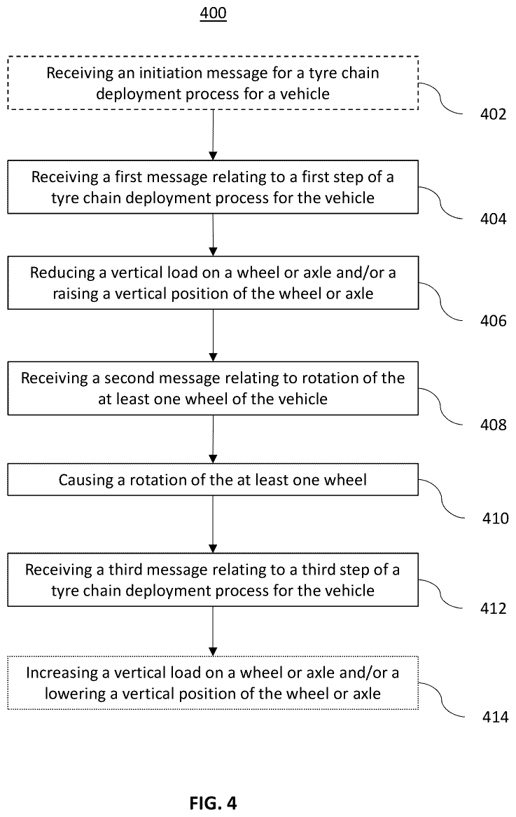

FIG. 4 is a flow chart of a computer-implemented method 400 according to an example. The method 400 includes a number of different functions and enables deployment of a tyre chain 170 on a wheel 110 of the vehicle 100 in an improved manner. The method 400 may be performed by the controller 140 and/or the computer system 150, for example by the processing circuitry 145 and/or the processing circuitry 155.

At 402, an initiation message for a tyre chain deployment process may be received. For example, the operator of the vehicle may put the vehicle 100 into a particular mode of operation for tyre chain deployment. To enter this mode of operation, it may be required that the vehicle 100 is at a standstill and that the parking brake is engaged. The initiation message may be generated based on an input provided to the vehicle 100 by the operator. The generation and implementation of the initiation message may be performed in substantially the same manner as discussed in relation to the method 300. The operator may position the tyre chain 170, for example drape the tyre chain 170 over at least one wheel 110 of the vehicle 100, before or after the initiation message is generated.

At 404, a first message is received relating to a first step of a tyre chain deployment process for the vehicle 100. In some examples, an initiation message is not required, and a tyre chain deployment process may be initiated based only on receiving a suitable input at 404. The first message may specify that a vertical load on at least one wheel 110 or axle 105 of the vehicle 100 is to be reduced, and/or that the vertical position of at least one wheel 110 or axle 105 of the vehicle 100 is to be raised.

The first message may be generated based on an input provided by the operator. For example, the operator may interact with a user interface located inside or outside of the vehicle 100, in the same manner discussed in relation to the method 300. In examples where the operator interacts with a user interface located outside of the vehicle 100, the operator does not need to re-enter the vehicle after positioning the chain 170. The operator input may correspond to one or more particular wheels 110 or axles 105 of the vehicle 100. As such, a message may be generated relating to one or more specific wheels 110 or axles 105 of the vehicle 100.

At 406, in response to receiving the first message at 404, a vertical load on a wheel 110 or axle 105 may be reduced and/or a vertical position of the wheel 110 or axle 105 may be raised. For example, the suspension system 125, for example an active suspension system, may be caused to reduce the load on one or more wheels 110 or axles 105 and/or raise the position of one or more wheels 110 or axles 105. In some examples, the operator may then position the tyre chain 170 accordingly. For example, the tyre chain 170 may be draped over at least one wheel 110 of the vehicle 100, as in 202, or laid in front of or behind the wheel 110. The operator may position the tyre chain 170, for example drape the tyre chain 170 over at least one wheel 110 of the vehicle 100, before or after the first message is generated or the corresponding action is performed.

At 408, a second message is received relating to a second step of a tyre chain deployment process for the vehicle 100. The second message relates to a wheel rotation step. In particular, the second message may relate to a rotation of the wheel 110 or axle 105 for which the vertical load has been reduced and/or the vertical position has been raised at 406, although it may additionally or alternatively relate to one or more other wheels 110 or axles 105 of the vehicle 100. The second message may be generated based on an input provided by the operator. For example, the operator may interact with a user interface located inside or outside of the vehicle 100, in the same manner discussed in relation to the method 300. In examples where the operator interacts with a user interface located outside of the vehicle 100, the operator does not need to re-enter the vehicle after positioning the chain 170. The operator input may correspond to a particular wheel 110 or axle 105 of the vehicle 100 and/or to a specific rotation of a wheel 110 or axle 105. As such, a message may be generated relating to rotation of a one or more specific wheels 110 or axles 105 of the vehicle 100, and/or to a specific rotation of a wheel 110 or axle 105.

At 410, in response to receiving the second message at 408, a rotation of the at least one wheel 110 of the vehicle 100 is caused. In particular, a rotation of the wheel 110 may be caused that exposes the unassembled part 176 of the chain 170, as in 204. The rotation may be provided by actuators associated with the wheel 110, for example one or more electrical machines 115 or service brakes 120. As tyre chains 170 are typically attached to a driven wheel 110 or axle 105 of the vehicle 100, it is possible to use the existing propulsion systems in the vehicle 100. Once a wheel 110 has been rotated, the operator may connect the exposed unassembled part 176 of the chain 170, such that the entire chain 170 is attached to the wheel 110.

In some examples, a specific angular rotation of the at least one wheel 110 of the vehicle 100 is caused. In some examples, if the resultant rotation of the wheel 110 is not sufficient, for example if the unassembled part 176 of the chain 170 is not adequately exposed, the operator may be enabled to make an additional input specifying a further rotation of the wheel 110. In some examples, braking of one or more other wheels 110 of the vehicle 100 is caused while the specified wheel 110 or axle 105 is rotated. In some examples, a steering angle is applied to the specified wheel 110 or axle 105. These function may be implemented in the same manner as discussed in relation to the method 300.

At 412, a third message is received relating to a third step of a tyre chain deployment process for the vehicle 100. The third message may specify that a vertical load on at least one wheel 110 or axle 105 of the vehicle 100 is to be increased and/or that the vertical position of at least one wheel 110 or axle 105 of the vehicle 100 is to be lowered. In particular, the third message may relate to the wheel 110 or axle 105 for which the vertical load has been reduced and/or the vertical position has been raised at 406, although it may additionally or alternatively relate to one or more other wheels 110 or axles 105 of the vehicle 100. The third message may be generated based on an input provided by the operator. For example, the operator may interact with a user interface located inside or outside of the vehicle 100, in the same manner discussed in relation to the method 300.

At 414, in response to receiving the third message at 412, a vertical load on the wheel 110 or axle 105 may be increased and/or the vertical position of the wheel 110 or axle 105 may be lowered. For example, the suspension system 125, for example an active suspension system, may be caused to increase the load on one or more wheels 110 or axles 105 and/or lower the position of one or more wheels 110 or axles 105.

The method 400 therefore enables a tyre chain deployment process that can be completed without the operator having to re-enter the vehicle, which is more efficient as there is no need for the operator to enter the vehicle 100, engage/disengage the parking brake, drive the vehicle 100 forwards or backwards so that the chain 170 is passed around the wheel 110, and then exit the vehicle to connect the remainder of the chain 170. By reducing a vertical load on a wheel 110 and/or raising a vertical position of the wheel 110 before it is rotated, the wheel 110 can be rotated more easily, for example without moving the vehicle 100. This is advantageous in instances where there is limited space. Traction problems due to slippery surfaces are thus avoided.

Whilst the tyre chain deployment process disclosed in relation to FIG. 4 relates to attachment of a chain 170, it will be appreciated that it can also be applied in order to detach a chain 170 from a wheel 110. For example, the operator may detach or decouple part of the chain 170 before making an input.

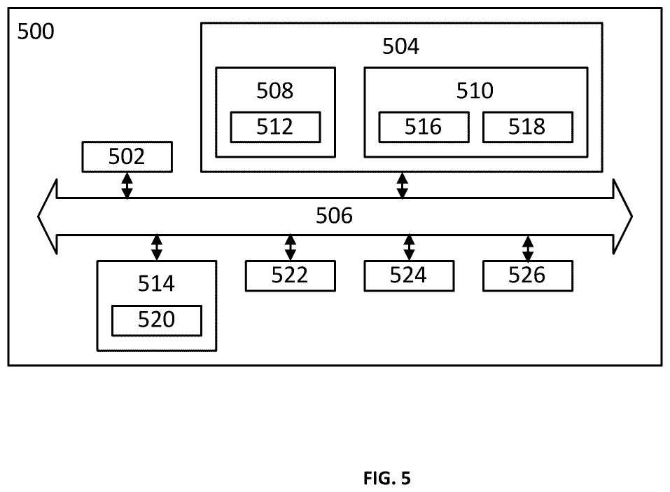

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN, an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A computer system (140, 150) comprising processing circuitry (145, 155) configured to receive a message relating to a wheel rotation step of a tyre chain deployment process for a vehicle (100), and, in response to receiving the message, cause a rotation of the at least one wheel (110) of the vehicle (100).

Example 2: The computer system (140, 150) of example 1, wherein the rotation is a specific angular rotation of the at least one wheel (110) of the vehicle (100).

Example 3: The computer system (140, 150) of example 1 or 2, wherein the processing circuitry (145, 155) is further configured to cause braking of one or more other wheels (110) of the vehicle (100) while the at least one wheel (110) is rotated.

Example 4: The computer system (140, 150) of any preceding example, wherein the processing circuitry (145, 155) is further configured to cause a steering angle to be applied to the at least one wheel (110) of the vehicle (100).

Example 5: The computer system (140, 150) of any preceding example, wherein the processing circuitry (145, 155) is further configured to cause a vertical load on at least one wheel (110) of the vehicle (100) to be decreased or increased.

Example 6: The computer system (140, 150) of any preceding example, wherein the processing circuitry (145, 155) is further configured to cause a vertical position of at least one wheel (110) of the vehicle (100) to be raised or lowered.

Example 7: The computer system (140, 150) of any preceding example, wherein the processing circuitry (145, 155) is configured to receive a first message relating to a first step of the tyre chain deployment process for the vehicle (100) and, in response to receiving the first message, cause a vertical load on at least one wheel (110) of the vehicle (100) to be decreased and/or a vertical position of at least one wheel (110) of the vehicle (100) to be raised, receive the message relating to a wheel rotation step as a second message relating to a second step of the tyre chain deployment process for the vehicle (100) and, in response to receiving the second message, cause the rotation of the at least one wheel (110) of the vehicle (100), receive a third message relating to a third step of the tyre chain deployment process for the vehicle (100), and, in response to receiving the third message, cause a vertical load on the at least one wheel (110) of the vehicle (100) to be increased and/or a vertical position of the at least one wheel (110) of the vehicle (100) to be lowered.

Example 8: The computer system (140, 150) of any preceding example, wherein the processing circuitry (145, 155) is configured to receive the message via a user interface of the vehicle (100) or a user device (160) of a vehicle operator.

Example 9: The computer system (140, 150) of any preceding example, wherein the message comprises a user input to a touch screen, a user gesture captured by a camera (130), or a voice command captured by a microphone.

Example 10: The computer system (140, 150) of any preceding example, wherein the at least one wheel (110) of the vehicle (100) is an individual wheel (110) of the vehicle (100) or comprises two wheels (110) on a common axle (105) of the vehicle (100).

Example 11: The computer system (140, 150) of any preceding example, wherein the at least one wheel (110) of the vehicle (100) is a driven wheel (110) of the vehicle (100).

Example 12: A vehicle (100) comprising the computer system (140, 150) of any preceding example.

Example 13: A computer-implemented method (300, 400) comprising, by processing circuitry (145, 155) of a computer system (140, 150) receiving (304, 408) a message relating to a wheel rotation step of a tyre chain deployment process for a vehicle (100), and, in response to receiving the message, causing (306, 410) a rotation of the at least one wheel (110) of the vehicle (100).

Example 14: The computer-implemented method (300, 400) of example 13, wherein the rotation is a specific angular rotation of the at least one wheel (110) of the vehicle (100).

Example 15: The computer-implemented method (300, 400) of example 13 or 14, further comprising causing braking of one or more other wheels (110) of the vehicle (100) while the at least one wheel (110) is rotated.

Example 16: The computer-implemented method (300, 400) of any of examples 13 to 15, further comprising causing a steering angle to be applied to the at least one wheel (110) of the vehicle (100).

Example 17: The computer-implemented method (300, 400) of any of examples 13 to 16, further comprising causing a vertical load on at least one wheel (110) of the vehicle (100) to be decreased or increased.

Example 18: The computer-implemented method (300, 400) of any of examples 13 to 17, further comprising causing a vertical position of at least one wheel (110) of the vehicle (100) to be raised or lowered.

Example 19: The computer-implemented method (300, 400) of any of examples 13 to 18, comprising receiving a first message relating to a first step of the tyre chain deployment process for the vehicle (100) and, in response to receiving the first message, causing a vertical load on at least one wheel (110) of the vehicle (100) to be decreased and/or a vertical position of at least one wheel (110) of the vehicle (100) to be raised, receiving the message relating to a wheel rotation step as a second message relating to a second step of a tyre chain deployment process for the vehicle (100) and, in response to receiving the second message, causing the rotation of the at least one wheel (110) of the vehicle (100), receiving a third message relating to a third step of the tyre chain deployment process for the vehicle (100), and, in response to receiving the third message, causing a vertical load on the at least one wheel (110) of the vehicle (100) to be increased and/or a vertical position of the at least one wheel (110) of the vehicle (100) to be lowered.

Example 20: The computer-implemented method (300, 400) of any of examples 13 to 19, comprising receiving the message via a user interface of the vehicle (100) or a user device (160) of a vehicle operator.

Example 21: The computer-implemented method (300, 400) of any of examples 13 to 20, wherein the message comprises a user input to a touch screen, a user gesture captured by a camera (130), or a voice command captured by a microphone.

Example 22: The computer-implemented method (300, 400) of any of examples 13 to 21, wherein the at least one wheel (110) of the vehicle (100) is an individual wheel (110) of the vehicle (100) or comprises two wheels (110) on a common axle (105) of the vehicle (100).

Example 23: The computer-implemented method (300, 400) of any of examples 13 to 22, wherein the at least one wheel (110) of the vehicle (100) is a driven wheel (110) of the vehicle (100).

Example 24: A computer program product comprising program code for performing, when executed by processing circuitry (145, 155), the computer-implemented method (300, 400) of any of examples 13 to 23.

Example 25: A non-transitory computer-readable storage medium comprising instructions, which when executed by processing circuitry (145, 155), cause the processing circuitry to perform the computer-implemented method (300, 400) of any of examples 13 to 23.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
receive a message relating to a wheel rotation step of a tyre chain deployment process for a vehicle; and
in response to receiving the message, cause a rotation of at least one wheel of the vehicle.

2. The computer system of claim 1, wherein the rotation is a specific angular rotation of the at least one wheel of the vehicle.

3. The computer system of claim 1, wherein the processing circuitry is further configured to cause braking of one or more other wheels of the vehicle while the at least one wheel is rotated.

4. The computer system of claim 1, wherein the processing circuitry is further configured to cause a steering angle to be applied to the at least one wheel of the vehicle.

5. The computer system of claim 1, wherein the processing circuitry is further configured to cause a vertical load on at least one wheel of the vehicle to be decreased or increased.

6. The computer system of claim 1, wherein the processing circuitry is further configured to cause a vertical position of at least one wheel of the vehicle to be raised or lowered.

7. The computer system of claim 1, wherein the processing circuitry is configured to:
receive a first message relating to a first step of the tyre chain deployment process for the vehicle;
in response to receiving the first message, cause a vertical load on at least one wheel of the vehicle to be decreased and/or a vertical position of at least one wheel of the vehicle to be raised;
receive the message relating to a wheel rotation step as a second message relating to a second step of the tyre chain deployment process for the vehicle;
in response to receiving the second message, cause the rotation of the at least one wheel of the vehicle;
receive a third message relating to a third step of the tyre chain deployment process for the vehicle; and
in response to receiving the third message, cause a vertical load on the at least one wheel of the vehicle to be increased and/or a vertical position of the at least one wheel of the vehicle to be lowered.

8. The computer system of claim 1, wherein the processing circuitry is configured to receive the message via a user interface of the vehicle or a user device of a vehicle operator.

9. The computer system of claim 1, wherein the message comprises a user input to a touch screen, a user gesture captured by a camera, or a voice command captured by a microphone.

10. The computer system of claim 1, wherein the at least one wheel of the vehicle is an individual wheel of the vehicle or comprises two wheels on a common axle of the vehicle.

11. The computer system of claim 1, wherein the at least one wheel of the vehicle is a driven wheel of the vehicle.

12. A vehicle comprising the computer system of claim 1.

13. A computer-implemented method comprising, by processing circuitry of a computer system:
receiving a message relating to a wheel rotation step of a tyre chain deployment process for a vehicle; and
in response to receiving the message, causing a rotation of at least one wheel of the vehicle.

14. The computer-implemented method of claim 13, wherein the rotation is a specific angular rotation of the at least one wheel of the vehicle.

15. The computer-implemented method of claim 13, further comprising one or more of:
causing braking of one or more other wheels of the vehicle while the at least one wheel is rotated;
causing a steering angle to be applied to the at least one wheel of the vehicle;
causing a vertical load on at least one wheel of the vehicle to be decreased or increased; and
causing a vertical position of at least one wheel of the vehicle to be raised or lowered.

16. The computer-implemented method of claim 13, comprising receiving a first message relating to a first step of the tyre chain deployment process for the vehicle and, in response to receiving the first message, causing a vertical load on at least one wheel of the vehicle to be decreased and/or a vertical position of at least one wheel of the vehicle to be raised, receiving the message relating to a wheel rotation step as a second message relating to a second step of a tyre chain deployment process for the vehicle and, in response to receiving the second message, causing the rotation of the at least one wheel of the vehicle, receiving a third message relating to a third step of the tyre chain deployment process for the vehicle, and, in response to receiving the third message, causing a vertical load on the at least one wheel of the vehicle to be increased and/or a vertical position of the at least one wheel of the vehicle to be lowered.

17. The computer-implemented method of claim 13, comprising receiving the message via a user interface of the vehicle or a user device of a vehicle operator.

18. The computer-implemented method of claim 13, wherein the message comprises a user input to a touch screen, a user gesture captured by a camera, or a voice command captured by a microphone.

19. A computer program product comprising program code for performing, when executed by processing circuitry, the computer-implemented method of claim 13.

20. A non-transitory computer-readable storage medium comprising instructions, which when executed by processing circuitry, cause the processing circuitry to perform the computer-implemented method of claim 13.
